(19) United States
(12) Patent Application Publication
(10) Pub. No.: US 2010/0175764 A1
(43) Pub. Date: Jul. 15, 2010

(54) Device for Controlling a Circuit that Consumes Compressed Gas, and a Vacuum Generator Making Use Thereof

(75) Inventors: Michel Cecchin, Montelier (FR); Pierre Milhau, Charpey (FR); Stephane Orieux, Toulouse (FR); Lucien Baldas, Castanet Tolosan (FR); Daniel Bouteille, Viroflay (FR)

Correspondence Address: Muncy, Geissler, Olds & Lowe, PLLC, 4000 Legato Road, Suite 310, FAIRFAX, VA, 22033, US

(73) Assignee: COVAL, Montelier (FR)

(21) Appl. No.: 12/160,982

(22) PCT Filed: Jan. 24, 2007
(86) PCT No.: PCT/FR2007/000133

§ 371 Date: Jul. 15, 2008

(30) Foreign Application Priority Data
Jan. 30, 2006 (FR) 06 00807

(51) Int. Cl. F15B 13/043; F15B 11/08

(52) U.S. Cl. 137/596.16; 91/446

(57) ABSTRACT

The invention relates to a device for controlling the opening and closing of a compressed gas consuming circuit (U), the device comprising a normally-closed two-position cutoff valve (2), said cutoff valve (2) having a pilot chamber (2a) and a counter-pilot chamber (2b) permanently in communication with a source (P) of compressed gas, directly for the pilot chamber (2a) and via a constriction (6) for the counter-pilot chamber (2b), the counter-pilot chamber including a purge branch connection (8) that is opened or closed by a two-position, two-port valve (9).

The present invention relates to a device for controlling the opening and the closing of a circuit that consumes compressed gas.

By way of example, such a circuit can lead to a pneumatic actuator or to a blow nozzle, an air amplifier, or above all a suction (vacuum) source that makes use of the Venturi effect.

### BACKGROUND OF THE INVENTION

Known control devices include a two-position valve connecting the consuming apparatus to a source of compressed air in a first state of the valve, and isolating it in a second state. Conventionally, the valve is a pneumatically controlled valve, the pneumatic control circuit including a three-port and two-position pilot solenoid valve (3/2 solenoid valve), i.e. a valve having a pressure orifice, an outlet orifice (leading to the controlled valve), and an exhaust orifice. To establish selective communication from the outlet orifice with one or the other of the pressure and exhaust orifices, it is necessary to make use of two seats if the valve is a valve of the kind having a valve member that is pressed against a seat. Such a technological configuration is expensive and also lends itself poorly to a high degree of miniaturization or to matching the low current levels of electronic circuits forming part of the electrical control for the pilot solenoid valve.

### OBJECT OF THE INVENTION

The present invention provides a solution to controlling the opening or the closing of a compressed air consuming circuit that is better adapted to ever more pressing requirements for miniaturization and low cost.

### SUMMARY OF THE INVENTION

To this end, in a first aspect, the invention thus provides a device for controlling the opening and closing of a compressed gas consuming circuit, the device comprising a normally-closed two-position cutoff valve, said cutoff valve having a pilot chamber and a counter-pilot chamber permanently in communication with a source of compressed gas, directly for the pilot chamber and via a constriction for the counter-pilot chamber, the counter-pilot chamber including a purge branch connection that is opened or closed by a two-position, two-port control valve.

Such a two-position and two-port control valve is much less expensive to fabricate than is a two-position and three-port valve, since when using a valve having a valve member that is pressed against a seat, only one seat is required.

The control valve, which in preferred manner is a solenoid valve, has one stable position, which position may either be the position in which the purge is open, or the position in which the purge is closed, depending on the behavior that is desired in the event of the electrical power supply failing, i.e. whether the gas consuming circuit should be open or closed, respectively.

In a second aspect, the invention provides a vacuum generator comprising in a body:
a nozzle and a mixer on a common axis;
a suction chamber between the nozzle and the mixer, constituting the vacuum source into which a suction channel opens out; and
a control device in accordance with the first aspect of the invention. Under such circumstances, the cutoff valve is advantageously a valve having a member that is normally held pressed against a seat, the valve member also presenting two opposite pilot surfaces, one that is subjected to the pressure that exists in the pilot chamber, and the opposite, other pilot surface being subjected to the pressure that exists in the counter-pilot chamber, such that when the pressures are equal, the valve member is held pressed against its seat, and in that the purge branch connection includes a seat on the same axis as the seat of the cutoff valve, with a valve member facing said seat and mounted to move between a spaced-apart position and a position in contact with the seat, the valve member being secured to the moving core of an electromagnetic actuator.

The transverse size of such an apparatus is determined by the means that produce the Venturi effect. The cutoff valve and the solenoid valve for controlling it in accordance with the invention can advantageously be housed in a volume that is no greater than that of the Venturi, such that units combining a plurality of Venturies of matching performance can be made compact and inexpensive to fabricate.

In a variant embodiment of the generator of the invention, it includes a blow channel for blowing compressed air into the suction channel, the blow channel itself including a normally closed cutoff valve that is fitted with a control device in accordance with the first aspect of the invention as specified above.

Other characteristics and advantages of the invention appear from the description given below of the few embodiments.

### BRIEF DESCRIPTION OF THE DRAWINGS

Reference is made to the accompanying drawings, in which:

FIG. 1 is a function diagram of the control device of the invention;

FIG. 2 shows an embodiment of a device complying with the functional diagram of FIG. 1;

FIG. 3 shows a vacuum generator in accordance with the invention;

FIG. 4 shows a detail of a variant embodiment of the FIG. 3 generator; and

FIG. 5 shows a vacuum generator in accordance with the invention and fitted with a blow channel.

### DETAILED DESCRIPTION OF THE INVENTION

In FIG. 1, reference U designates a compressed gas consuming circuit, and reference P designates the end of a source of gas under pressure. The control device 1 of the invention comprises a cutoff valve 2 having two positions and two ports, with a stable state corresponding to cutting off communication between the source P and the circuit U (as shown), the stable state being obtained and maintained in particular by the effect of a spring 3 incorporated in the valve.

The valve includes a pilot chamber 2a and a counter-pilot chamber 2b, each chamber being connected permanently to the pressure side P. More exactly, the pilot chamber 2a is fed permanently with fluid under pressure by a pilot channel 4, while the counter-pilot chamber 2b is permanently fed with fluid under pressure by a counter-pilot channel 5, in which there are mounted both a constriction 6 and a filter 7.

The counter-pilot chamber 2b includes a purge channel 8 having a two-position, two-port solenoid valve 9 mounted thereon with a stable position that is obtained under drive from a spring 10 in the absence of the valve being excited, the stable position being, in this example, the position in which the purge channel 8 is closed. In its second position, the valve 9 is moved against the effect of the spring 10 by an electromagnetic actuator 11 so that in this second position, the valve 9 puts the first channel 8 into communication with the exhaust 12.

As shown, the compressed gas consuming circuit is isolated from the pressure source P. The pilot and counter-pilot chambers 2a and 2b are at the same pressure, the pressure of the pressurized fluid source, and since the areas exposed to said pressure are identical, the spring 3 is preponderant and holds the valve 2 in its closed position. The same result could be obtained without a spring if the counter-pilot pressure generates a force on the moving part of the valve 2 that is greater than that generated by the pilot pressure (which pressure is the same in this example). An electrical control signal is then fitted to the electromagnetic actuator 11 of the valve 9 and causes it to change state. This purges the counter-pilot chamber 2b at least in part, leading to a corresponding drop in pressure. The pressure in the pilot chamber 2a then becomes preponderant, overcoming the force from the spring 3, and the valve 2 changes state. The compressed gas consuming circuit U is thus connected to the source P. Throughout this period, gas leaks through the duct 5 and the purge 8. Nevertheless, this leak is small, specifically because of the constriction 6 that presents a flow section that is much smaller than that of the duct 8. When electricity ceases to be applied to the valve 9, it returns to its position closing the duct 8. The pressure is restored in the counter-pilot chamber 2b, which then, together with the force from the spring, counters the force from the pilot chamber 2a so as to place the valve 2 in its closed position.

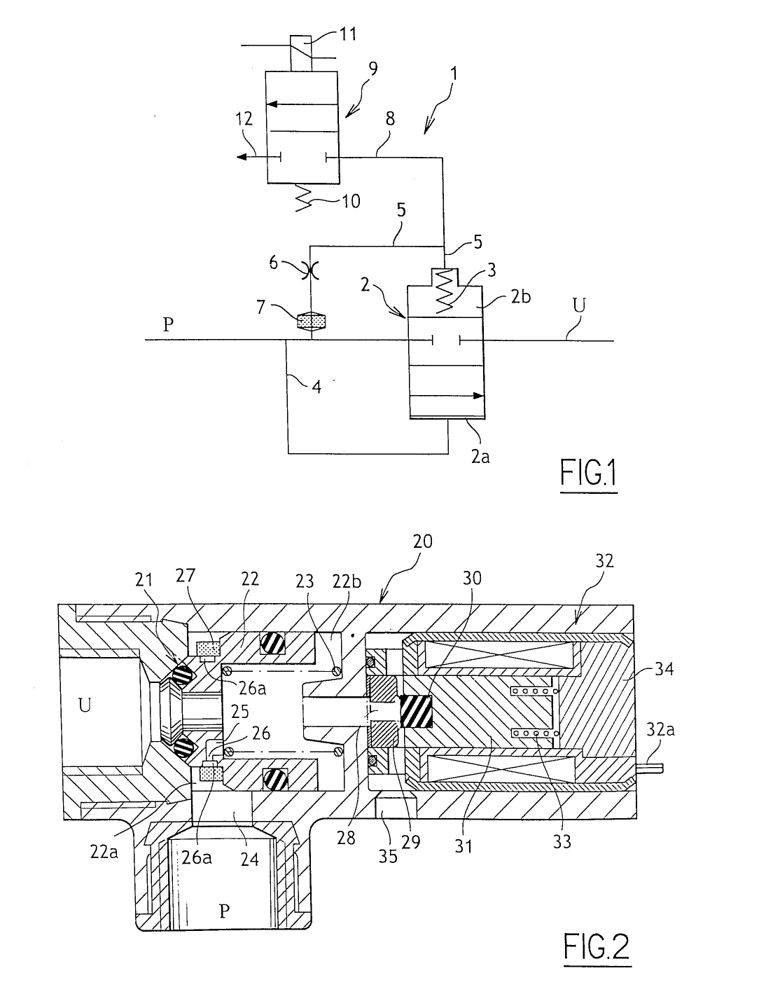

FIG. 2 shows an embodiment of a device in accordance with the functional diagram of FIG. 1, which device comprises a body 20. The body 20 has a seat 21 against which a valve member 22 bears under drive from a spring 23. The seat 21 is formed in a insert that is fitted in the body 20, e.g. by spikes, said insert defining a connection element for connection to the compressed gas circuit.

By means of a lateral endpiece of the body 20, the device can be connected via any appropriate means to the pressure source P. This pressure source feeds a chamber 22a via a duct 24, which chamber constitutes a pilot chamber for the valve member 22. This chamber 22a, and thus the duct 24, communicates with a counter-pilot chamber 22b for the valve member 22 via channel 25 formed in the body itself of the valve member 22. This counter-pilot channel 25 possesses a constriction 26, a groove 26a of the valve member 22 from which the constriction 26 extends, and a filter 27 covering the groove 26a. The function of the filter is to prevent the constriction becoming clogged by any impurity in the fluid under pressure.

The counter-pilot chamber 22b communicates with the atmosphere via a purge channel 28 passing through a seat 29 that can be closed by a valve member 30. The valve member 30 is carried by the moving core 31 of a solenoid valve 32 and rests against the seat 29 under drive from a spring 33 placed between the moving core 31 and a yoke 34 of the solenoid valve. When electricity is fed to the solenoid valve it tends to move the core 31 against the yoke 34 against the effect of the spring 33, thereby lifting the valve member 30 off the seat 29. This serves to purge the counter-pilot chamber 22b. Reference 32a designates an electrical connection terminal for the solenoid valve. The exhaust from the solenoid valve is referenced 35 in FIG. 2.

When the solenoid valve 32 is not excited, the pressure P exists in the chamber 22a and in the chamber 22b. The area of the valve member 22 that is exposed to the pressure in the chamber 22b is greater than the area of the same valve member that is exposed to the pressure in the chamber 22a. As a result, and also with assistance from the spring 23, the valve member is pressed against its seat 21 and communication between P and U is interrupted. Feeding electricity to the solenoid valve 22 lifts the valve member 30 off its seat 29 and places the chamber 22b in communication with the exhaust 35. The pressure in the chamber 22b thus drops, even if it continues to be fed via the channel 25 and the constriction 26 of flow section that is much smaller than that of the channel 28 in the seat 29. The pressure in the chamber 22a thus exerts a force on the valve member 22 that is capable of moving the valve member, even against the return spring 23. Under such conditions, the valve member 22 is lifted off its seat 21 and communication is established between the pressure source U and the compressed gas consuming channel U. When electricity ceases to be fed to the valve 22, the valve member 30 closes against and the pressure in the chamber 22b is restored progressively and the force from the spring 23 on the valve member 22 again becomes preponderant causing the valve member to be pressed back against its seat 21. Under these conditions, P-U communication is once more interrupted.

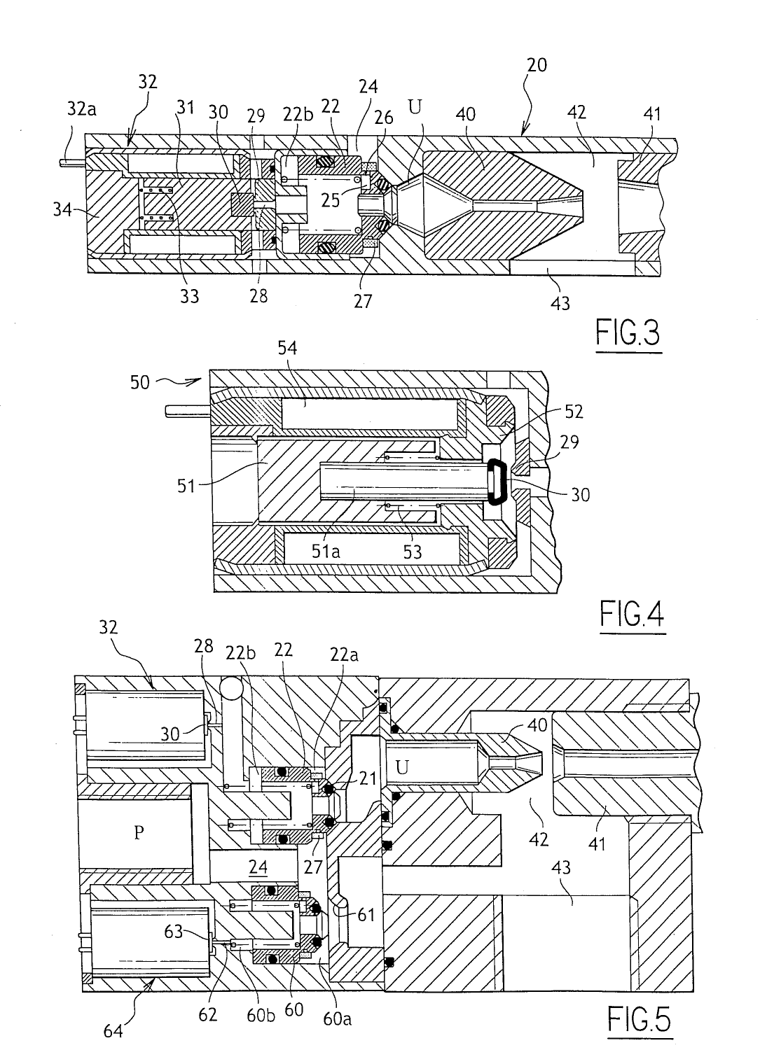

FIG. 3 shows most of the elements described above with reference to FIG. 2 together with the same references, FIG. 3 showing a vacuum generator. Beyond the seat 21, the pressure-consuming circuit U is constituted by a nozzle 40, a mixer 41 spaced apart from the nozzle 40 so as to give a Venturi effect that results in suction being created in the chamber 42 disposed between the nozzle and the mixer. The chamber 42 is the vacuum generator for a suction channel 43, e.g. connected in known manner to a suction cup.

The advantage of the control device of the invention, when applied to a vacuum generator, is that compressed air is consumed by the control device only when the vacuum generator is likewise also consuming compressed air. Since the consumption by the control device is much less than the consumption of compressed air needed to generate the vacuum, this “drawback” due to control device consumption is entirely acceptable in the present configuration. Furthermore, it should be observed that all of the functional components are housed within the body 20 in a single direction constituted by their common axis. If the body 20 is made of plastics material, it is possible to secure the insert forming the nozzle 40 and the mixer 41 by spikes in one end of the body 20 and then to position the valve member 22, the seat 29, and the solenoid valve 32 via the open opposite end of the body 20. This design considerably simplifies fabrication of the device.

In FIG. 3, it can be seen that when no electricity is fed to the solenoid valve 32, the valve member 30 rests against the seat 29 under thrust from the spring 33 and isolates the pilot chamber 22b from the exhaust. In this configuration, the valve member 29 is forced against its seat 21 and the Venturi is isolated from the compressed gas feed. In certain applications, it is desirable or useful for the suction provided by the Venturi to continue, in particular in the event of an electricity failure. It is then necessary for the pilot chamber 22b to be in communication with the exhaust in the absence of electricity being fed to the pilot solenoid valve. FIG. 4 shows a solenoid valve 50 of this type. It is shown when not fed with electricity and the valve member 30 is remote from the seat 29. The valve member 30 is secured to the moving core 51 via a non-magnetic rod 51a that, in the absence of electricity feed, is held apart from the yoke 52 by a spring 53. Powering the coil 54 of the valve 50 attracts the moving core 51 towards the yoke 52 and presses the valve member 30 against the seat 29. Thus, with a solenoid valve that is normally open, the valve for cutting off the feed to the Venturi is open in the event of an electricity feed failure and is closed when the electricity feed is delivered to the valve 40.

Finally, FIG. 5 shows most of the elements described above with reference to FIG. 3 and having the same references. The compressed gas feed duct 24 to the pilot chamber 2a of the valve member 22 also opens out into a pilot chamber 60a for a valve member 60 that co-operates with a seat 61 via which the compressed gas can reach the suction duct 43, when the valve member 60 is spaced apart therefrom.

The valve member 60 is identical to the valve member 22 with a counter-pilot chamber 60b that can be connected to the exhaust by opening a purge duct 62. This opening is achieved by moving a valve member 63 of a pilot solenoid valve 64 similar to the pilot solenoid valve 32 that provides communication between the pressure source P and the components 40 and 41 defining the suction chamber 42.

It will be understood that by operating the solenoid valves 32 and 64 sequentially, either suction is established in the suction duct 43, thereby enabling a suction cup to take charge of a workpiece, or else extra pressure is established in this duct 43 serving to expel rapidly the workpiece previously taken by the suction cup.

1-8. (canceled)

9. A device for controlling the opening and closing of a compressed gas consuming circuit (U), the device comprising a normally-closed two-position cutoff valve (2), said cutoff valve (2) having a pilot chamber (2a) and a counter-pilot chamber (2b) permanently in communication with a source (P) of compressed gas, directly for the pilot chamber (2a) and via a constriction (6) for the counter-pilot chamber (2b), the counter-pilot chamber including a purge branch connection (8) that is opened or closed by a two-position, two-port control valve (9).

10. A device according to claim 9, wherein the pilot valve (9) of the purge channel (8) is a solenoid valve having one stable position.

11. A device according to claim 10, wherein the stable position is the position for closing the channel (8).

12. A device according to claim 10, wherein the stable position of the solenoid valve is the position for opening the channel (8).

13. A vacuum generator comprising, in a body (20):
a nozzle (40) and a mixer (41) on a common axis;
a suction chamber (42) between the nozzle and the mixer, constituting the vacuum source into which a suction channel (43) opens out; and
a control device according to claim 1 for controlling the feeding of compressed gas to the nozzle (40);
wherein the cutoff valve is a valve having a member (22) that is normally held pressed against a seat (21), the valve member (22) also presenting two opposite pilot surfaces, one that is subjected to the pressure that exists in the pilot chamber (22a), and the opposite, other pilot surface being subjected to the pressure that exists in the counter-pilot chamber (22b), such that when the pressures are equal, the valve member (22) is held pressed against its seat (21), and wherein the purge branch connection (28) includes a seat (29) on the same axis as the seat (21) of the cutoff valve, with a valve member (30) facing said seat and mounted to move between a spaced-apart position and a position in contact with the seat (29), the valve member (30) being secured to the moving core (31) of an electromagnetic actuator (32).

14. A vacuum generator according to claim 13, wherein the moving core (51) is held apart from the seat (29) in the absence of electricity being fed to the actuator (50).

15. A vacuum generator according to claim 13, wherein the moving core (31) is held close to the seat (29) in the absence of electricity being fed to the actuator (32).

16. A generator according to claim 13, including a channel for blowing compressed air into the suction channel (43), wherein the blow channel includes a normally closed cutout valve (60, 61), fitted with a control device for controlling opening and closing of a compressed gas consuming circuit (U), the device comprising a normally-closed two-position cutoff valve (2), said cutoff valve (2) having a pilot chamber (2a) and a counter-pilot chamber (2b) permanently in communication with a source (P) of compressed gas, directly for the pilot chamber (2a) and via a constriction (6) for the counter-pilot chamber (2b), the counter-pilot chamber including a purge branch connection (8) that is opened or closed by a two-position, two-port control valve (9).
